(19) United States
(12) Patent Application Publication
(10) Pub. No.: US 2009/0175375 A1
(43) Pub. Date: Jul. 9, 2009

(54) Joint Optimization of Linear Pre-Filtering and Nonlinear Vector Perturbation for MIMO Multiuser Precoding

(75) Inventor: Jianzhong Zhang, Irving, TX (US)

Correspondence Address: HARRINGTON & SMITH, PC, 4 RESEARCH DRIVE, Suite 202, SHELTON, CT, 06484-6212, US

(73) Assignee: Nokia Corporation, Espoo (FI)

(21) Appl. No.: 12/085,505

(22) PCT Filed: Nov. 23, 2005
(86) PCT No.: PCT/US2005/042746

§ 371 Date: May 22, 2008

(51) Int. Cl. H04B 7/02; H04L 27/00

(52) U.S. Cl. 375/267; 375/295; 375/316

(57) ABSTRACT

A method includes jointly optimizing a vector perturbation and a linear pre-filter, applying said vector perturbation to a transmit data vector (s) to produce an output vector, applying said linear pre-filter (G) to said output vector to produce a transmit signal (x), and computing a scaling factor (γ).

### BACKGROUND OF THE INVENTION

1. Field of the Invention

The present invention relates generally to a system for maintaining high print speed while storing secure data.

2. Background Information

Multiple Transmit Multiple Receive (MIMO) systems based on multiple transmit and receive antennas hold promise for higher spectral efficiency of wireless communications systems. Early work on MIMO systems has focused on optimal signaling and coding schemes for a point-to-point configuration, where a base station (BS) communicates with only one mobile station (MS) in a given time, frequency, or code slot assigned to that MS by conventional multiplexing schemes such as time division multiple access (TDMA), orthogonal frequency division multiple access (OFDMA) or code division multiple access (CDMA). However, it has been discovered that with multiple antennas at the BS and MSs, it is possible for the BS to serve several MSs in the same time, frequency or code slot. By so doing, there not only results higher capacity for the system, but also better quality of service (QoS) measures, such as packet delay, that are experienced by individual users in the cell.

With reference to FIG. 1a, there is illustrated a MIMO multi-user system. As illustrated, the base station (BS) 1 includes a plurality of antennas 1a, 1b and is in communication with or more mobile stations (MSs) 2. Assuming that the channel state information of all MSs 2 is available at the BS 1, the sum capacity of such a MIMO broadcast channel has been established using an information theoretic known-interference-cancellation argument called dirty paper coding (DPC), or Costa coding.

Furthermore, it has been shown that the sum capacity of the MIMO broadcast channel with DPC is superior to the capacity achieved by conventional multiplexing schemes such as TDMA. It has been further shown that the DPC precoding achieves the entire capacity region of the MIMO broadcast channel.

Although DPC coding promises an optimal capacity region of a MIMO broadcast channel, designing coding and signaling schemes to achieve the optimal DPC capacity proves challenging. To circumvent the difficulty when designing such schemes, most of the practical MIMO multi-user (MU) precoding schemes attempt to achieve the near-capacity instead. In accordance with one such scheme, a zero forcing (ZF) approach is used to pre-eliminate other user interferences. In another scheme, in order to lower the transmit power required when employing the ZF method, a regularized inversion approach has been proposed. Such a method is similar to preexisting Minimum Mean Square Error (MMSE) precoding schemes.

In accordance with another such scheme, the Tomlinson-Harashima (TH) precoding method, which was originally proposed for inter-symbol interference pre-equalization, has been shown to be applicable to the MIMO MU precoding problem and slightly outperforms linear ZF or Minimum Mean Square Error (MMSE) algorithms. According to yet another scheme, the transmit and receive signaling is optimized for a multicast setting where the BS signals are intended for all the users in the cell.

It is further known to utilize a vector-perturbation method in order to perturb the transmit data vectors with integer vectors multiplied by a given modulo interval. Simply put, vector perturbation operates to reduce the transmission power required by the BS 1. In the instance where the transmit power of the BS 1 is fixed, vector perturbation operates to improve the signal to noise ratio of the transmission.

This perturbed data vector is processed by a pre-filter before transmission to the MS 2. The impact of this perturbation is removed at the receiver (MS 2) by a modulo function. It has been shown that, compared to linear ZF and MMSE precoding methods, significant diversity gain can be achieved via a method incorporating vector perturbation. The optimal integer perturbation vectors are obtained using a sphere encoding algorithm. To reduce the computational complexity involved in obtaining the optimal linear perturbation vectors, a near-optimal lattice reduction algorithm can be applied.

However, in either instance, the pre-filters are optimized according to linear ZF/MMSE criterions. Specifically, they are optimized without regard to the fact that the signal to be pre-filtered will have previously undergone vector perturbation. As a result, the output of the pre-filtering is not guaranteed to be optimal when the input signal has experienced non-linear vector perturbation.

### SUMMARY OF THE INVENTION

In accordance with an exemplary embodiment of the invention, a method includes jointly optimizing a vector perturbation and a linear pre-filter, applying said vector perturbation to a transmit data vector (s) to produce an output vector, applying said linear pre-filter (G) to said output vector to produce a transmit signal (x), and computing a scaling factor (γ).

In accordance with an exemplary embodiment of the invention, a method for transmitting a transmit signal includes jointly optimizing a vector perturbation and a linear pre-filter, applying said vector perturbation to a transmit data vector (s) at a transmitter to produce an output vector, applying said linear pre-filter (G) to said output vector at said transmitter to produce a transmit signal (x), computing a scaling factor (γ), and transmitting said transmit signal and said scaling factor to at least one mobile station (MS).

In accordance with an exemplary embodiment of the invention, a transmitter includes a means for jointly optimizing a vector perturbation and a linear pre-filter (G), a means for applying said vector perturbation to a transmit data vector (s) at a transmitter to produce an output vector, a means for applying said linear pre-filter to said output vector at said transmitter to produce a transmit signal (x), a means for computing a scaling factor (γ), and a means for transmitting said transmit signal and said scaling factor to at least one mobile station (MS).

In accordance with an exemplary embodiment of the invention, a portable electronic device includes a means for receiving a transmit signal and a scaling factor wherein said transmit signal comprises a transmit data vector to which is applied a vector perturbation and a linear pre-filter and wherein said vector perturbation and said linear pre-filter are jointly optimized, and a means for applying said scaling factor to said transmit signal to derive said transmit data vector.

In accordance with an exemplary embodiment of the invention, a computer program product embodied in a computer readable medium the execution of which by a data processor of a base station includes the operations of jointly optimizing a vector perturbation and a linear pre-filter, applying said vector perturbation to a transmit data vector (s) at a base station (BS) to produce an output vector, applying said linear pre-filter (G) to said output vector at said BS to produce a transmit signal (x), and computing a scaling factor (γ).

### BRIEF DESCRIPTION OF THE DRAWINGS

The foregoing aspects and other features of the present invention are explained in the following description, taken in connection with the accompanying drawings, wherein:

FIG. 1a is a diagram of a MIMO network configuration known in the art.

FIG. 1b is a diagram of an exemplary embodiment of a network configuration for practicing the invention.

FIG. 2 is an illustration of an exemplary embodiment of the vector perturbation and linear pre-filtering of the invention.

FIG. 3 is an illustration of an another exemplary embodiment of the vector perturbation and linear pre-filtering of the invention.

FIG. 4 is a diagram of exemplary embodiments of matrices of the invention.

FIG. 5 is a graph of a simulation of the results obtained when implementing an exemplary embodiment of the invention versus prior art methodologies.

FIG. 6 is a logic diagram of an exemplary embodiment of a method of the invention.

FIG. 7 is an illustration of equations derived for an exemplary embodiment of the invention.

FIG. 8 is an illustration of equations derived for an exemplary embodiment of the invention.

FIG. 9 is an illustration of equations derived for an exemplary embodiment of the invention.

### DETAILED DESCRIPTION

In an exemplary embodiment of the invention, there is provided a method that optimizes the ZF/MMSE pre-filtering and the vector perturbation performed on a transmit data vector to produce an output vector. Specifically, both the ZF/MMSE pre-filtering and the vector perturbation are jointly optimized to minimize the transmission power required at a transmitter, such as a base station, in communication with one or more receivers, such as mobile stations. As described more fully below, this joint optimization is enabled by an effective decoupling of these two optimization steps. Although the pre-filters may still be optimized according to ZF or MMSE criterions, the impact of vector perturbation is taken into account in the optimization process.

In the case of ZF pre-filtering, the decoupling is straightforward as the constraints imposed by ZF pre-filtering dictate a relatively simple form of a pre-filter.

In the case of MMSE pre-filtering, there is first derived an approximate expression of the correlation matrix of the transmit signal. It is shown that the optimization of a MMSE pre-filter can also be decoupled from the optimization of the perturbation vectors. An analytical solution of the optimal MMSE pre-filter is obtained utilizing, as a non-limiting example, the Lagrange multiplier method. Finally, using a practical system as an example, it is illustrated by way of numerical simulations that exemplary embodiments of the joint optimization algorithm of the invention work well with various perturbation vector search algorithms, such as the sphere encoder, the lattice reduction algorithm, and the QR Decomposition M Algorithm (QRD-M) encoder. It is further evident from the results of the simulation that the joint optimization algorithm of the invention outperforms the linear ZF or MMSE precoding methods known in the art.

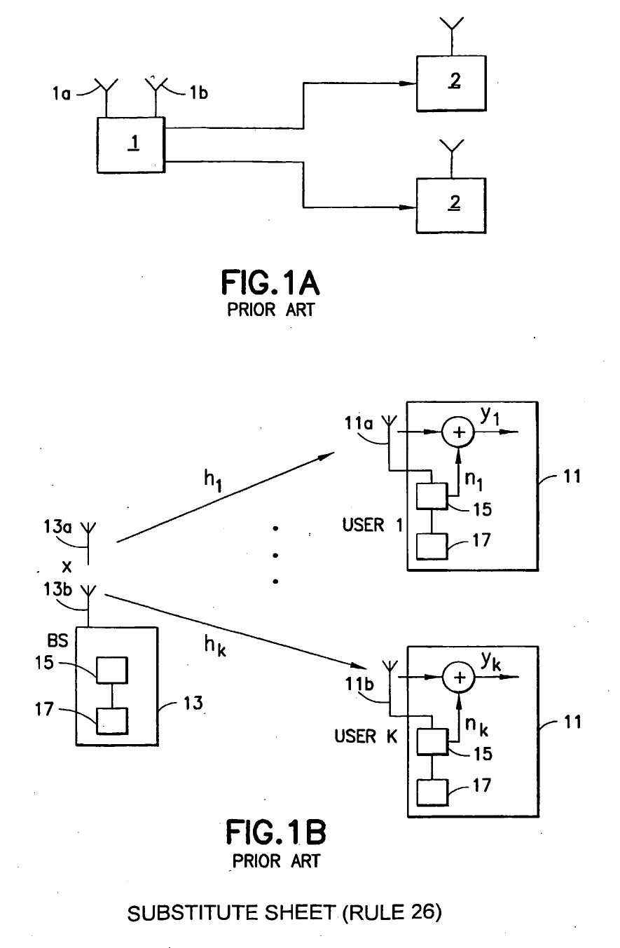

With reference to FIG. 1b, there is illustrated an exemplary embodiment of a network configuration for practicing the invention. As illustrated, the BS 13 includes a plurality of antennas 13a, 13b coupled to a processing unit 15 that is coupled to a memory 17. The processing unit 15 is any digital computing device, such as a central processing unit (CPU), capable of storing, retrieving, and executing machine readable instructions so as to engage in electronic communication with one or more MS. The processing units 15 in both the BS 13 and the MSs 11 can be employed to perform vector perturbation, linear pre-filtering, as well as decoding and demodulating. Memory 17 is any device or medium capable of storing and retrieving digital data. Similarly, each MS 11 is formed of at least one antenna coupled to a processing unit 15 that is, in turn, coupled to a memory 17.

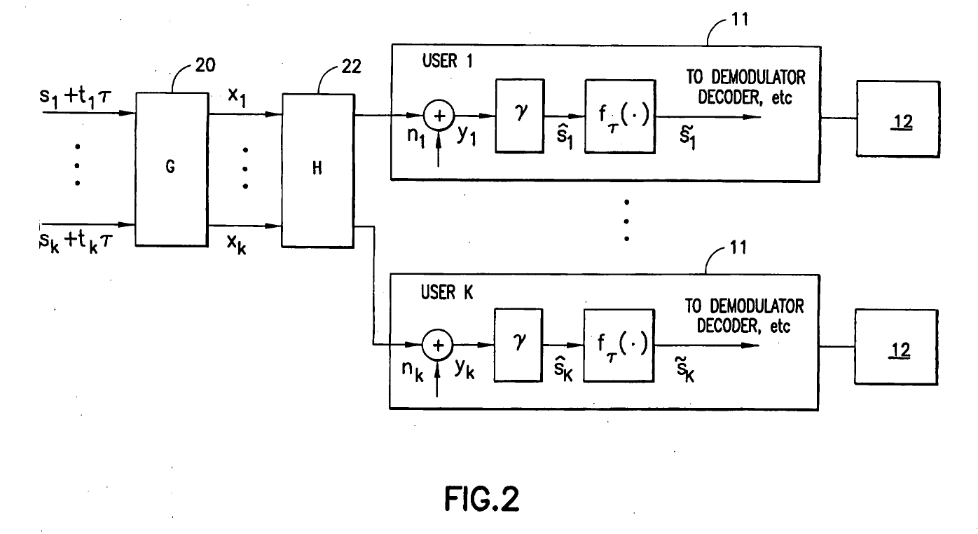

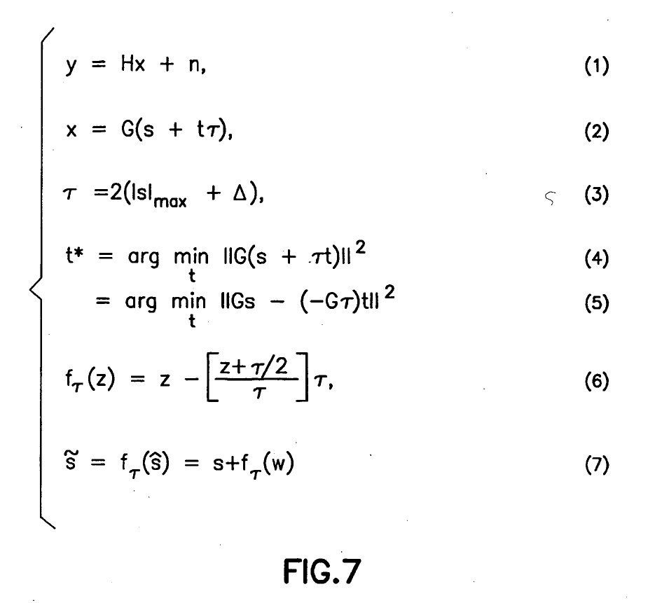

With reference to FIG. 2, there is illustrated a block diagram illustrating an exemplary embodiment of a vector perturbation apparatus in accordance with exemplary embodiments of the invention. The illustrated block diagram corresponds to the system of FIG. 1b wherein the transmitter, or BS 13, has Nₜ transmit antennas and the receivers, MSs 11, each have one receive antenna. It is assumed that there are K users in the cell, and the condition K<=Nₜ is enforced to ensure that there is enough spatial degrees of freedom in the system. For purposes of discussion and exposition, without loss of generality, it is assumed that K=Nₜ. In addition, the equations relating to the following exemplary derivation are illustrated in FIG. 7 and are referred to by their accompanying equation numbers. Applying such assumptions, one can let x=[x₁, . . . , x_{K}]^{T} be the transmit signal vector across all transmit antennas 13a, 13b, and y=[y₁, . . . , y_{K}]^{T} be the receive signal collected at all K users. As a result, one derives equation (1) where H=[h₁, . . . , h_{K}]^{T} is a K×K channel matrix, and n is the additive white Gaussian noise where n˜σₙ²I). Note that hᵢ^{T} is the channel vector coupling the i^{th} user and all the transmit antennas. The average transmit power is assumed to be E|x|²=Eₜₓ.

With continued reference to FIG. 2, there is now described the vector perturbation method. When utilizing vector perturbation, the transmit signal x is given by equation (2) where s is the K times 1 transmit data vector, block G 20 represents a K times K transmit filter matrix that is a function of the channel matrix H 22 and scaling factor γ (discussed more fully below), t is an integer perturbation vector, and τ is a positive real number indicating the granularity of perturbation. Typically, τ is chosen in accordance with equation (3) where |s|ₘₐₓ is the absolute value of the constellation symbols with largest magnitude and Δ is the spacing between constellation points. For a given filter matrix G, a given transmit data vector s, and a chosen constant τ, the optimal perturbation vector is obtained by minimizing the instantaneous transmit power |x|² as illustrated in equation (4) and (5).

Thus, the solution may be viewed as a closest lattice point search problem whose goal is to find the lattice point that is closest to the vector Gs. Note that the basis of the lattice is −Gτ. There exist several algorithms to solve this particular lattice search problem, including the sphere decoder (also called the “sphere encoder” in this context), the lattice reduction algorithm, and the QRD-M algorithm.

For purposes of clarity, it is again noted that prior art methodologies seek to optimize the transmit filter matrix G without regard to the fact that the transmit data vector, \dot{s}, has undergone vector perturbation. In short, G is optimized as though the linear pre-filtering operation is defined as x=G(s) even though, in operation, the pre-filtering operation is defined, as in equation (2), as x=G(s+tr).

In contrast to existing methodologies, in an exemplary embodiment of the invention, there is introduced the scaling factor γ to account for the average transmission power constraint E|x|=Eₜₓ discussed previously. As defined, γ is a function of Eₜₓ and the receiver, or MS 11, employs knowledge of γ for achieving proper detection. Nevertheless, communicating γ from the BS 13 to MSs 11 requires few resources as γ depends on the average power, not the instantaneous power. In practice, γ is repeatedly computed by BS 13 as necessary and transmitted to each MS 11 in communication with BS 13. γ may be recomputed, at a minimum, each time there is a change in the channel over which communication between a BS 13 and a MS 11 takes place. γ can be recomputed as often as one time for every packet of data transmitted from the BS 13 to an MS 11. In an exemplary embodiment, γ is transmitted from a BS 13 to a MS 11 over any suitable channel, including, but not limited to, data channels and control channels. The received signal vector γ is scaled by γ to produce ŝ=γy.

The design goal of either the ZF or MMSE filtering approach is to choose G and γ such that ŝ is close to the transmit signal plus perturbation s+tτ, i.e, ŝ=s+tτ+w where w is a small noise. Afterward, the modulo function of equation (6) is applied to ŝ to remove the perturbation vector. Finally, the signal after the modulo function of equation (7) is used to drive the demodulator/decoder 12 in the MSs 11.

It is therefore evident that, given G and γ, the optimal perturbation vector can be found by solving the closed lattice point search problem. It is therefore desirable to derive the optimal G and γ given the average power constraint. As discussed in the following, an exemplary embodiment of the invention provides a solution for the derivation of G and γ based on a ZF constraint. There is then provided a derivation of a solution based upon the restraints attendant to MMSE. Furthermore, it will be shown that with the ZF constraints, the average transmission power averaged over both data vectors and channel realizations in a fast fading scenario goes to infinity even with perturbation.

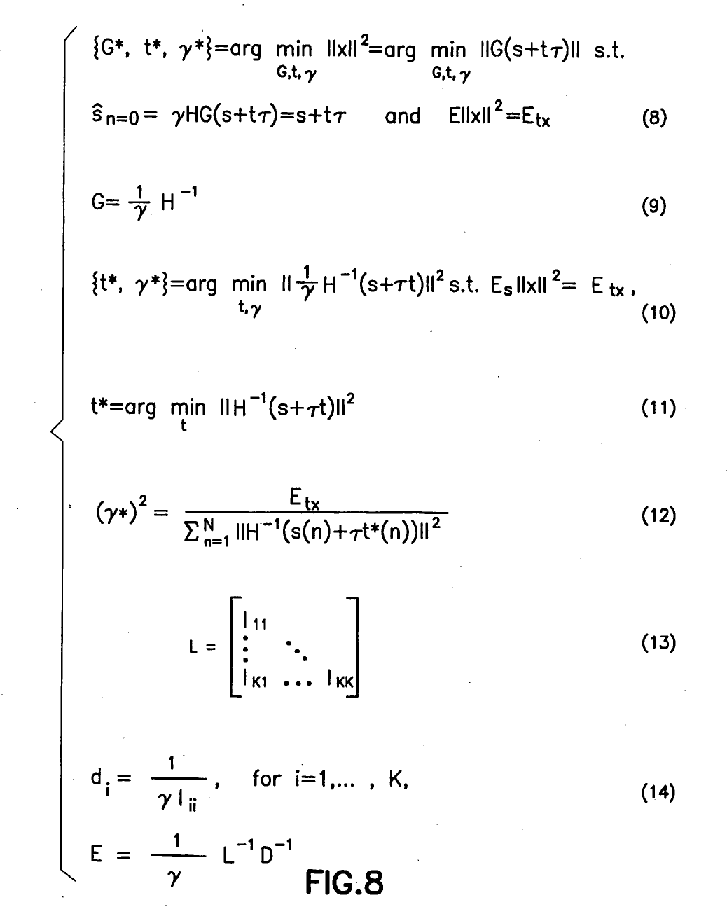

There is herein discussed the joint optimization of a ZF pre-filter and vector perturbation wherein equations relating to the following exemplary derivation are illustrated in FIG. 8 and are referred to by their accompanying equation numbers. One starts from the joint optimization problem of equation (8) where the first constraint is the ZF condition dictating that the noise-free received signal ŝₙ₌₀ is the same as the perturbed transmit data vector, and the second constraint states that the average transmission power is fixed. Note that there is employed the terminology (•)* to denote the optimal solution in the discussion that follows. One next proceeds to show that, in the ZF solution, the optimization of the ZF pre-filter and the perturbation vectors can be decoupled.

The first constraint dictates that the linear filter matrix G is given by equation (9) where it is assumed that H is full rank. The joint optimization problem of equation (8) reduces to equation (10)

However, since

$${min}_{t , γ} {\vert \frac{1}{γ} {H}^{- 1} ( s + τ t ) \vert}^{2} = {min}_{γ} \frac{1}{{γ}^{2}} {min}_{t} {\vert {H}^{- 1} ( s + τ t ) \vert}^{2} ,$$

the optimization of t and γ can be further decoupled such that the optimal t for a given transmit data vector is given by equation (11) and the optimal γ can be obtained from the average transmission power constraint, after all the perturbation vectors are found for each data vectors in the codeword of equation (12) where n is the symbol index and it is assumed there are N symbols in one codeword.

In the above ZF solution, both t and γ are data dependent. Since one knows γ is a scaling factor that accounts for the average transmission power, it is desirable to find an optimal γ solution that is only dependent on the average power Et, and the channel. To this end, an approximate expression of average transmission power for the ZF-based vector perturbation can be derived following the approach used to derive the average transmission power of the TH precoder. First, it is advantageous to reorganize the transmission block illustrated in FIG. 2.

With reference to FIG. 3, there is illustrated the block diagram of FIG. 2 wherein the filter matrix G 20 is broken into three parts: a diagonal matrix D 20A, a lower triangular matrix E 20B whose diagonal elements are ones, and a unitary matrix Q 20C derived from a LQ decomposition of H: H=L Q where L is a lower triangular matrix shown in equation (13) and Q is a unitary matrix. Substitute G=Q^{H}ED into the ZF constraint γHG=I, and one has γ(L Q)(Q^{H}ED)=1, and consequently equation (14)

As has been shown, the decoupling of the optimization of the ZF filter and the perturbation vectors is possible since the ZF constraint dictates a simple form for the filter matrix

$$G = \frac{1}{γ} {H}^{- 1} .$$

This straightforward decoupling approach is, however, not directly applicable if the MMSE metric is used in place of ZF. Existing methodologies seek to circumvent the problems associated with the decoupling of an MMSE filter and the perturbation filter by assuming

$$G = \frac{1}{γ} {( {HH}^{H} + α I )}^{- 1} {H}^{H} ,$$

the optimal linear MMSE filter when no vector perturbation is present. However, this choice of filter is not optimal and the parameter α can not be analytically obtained.

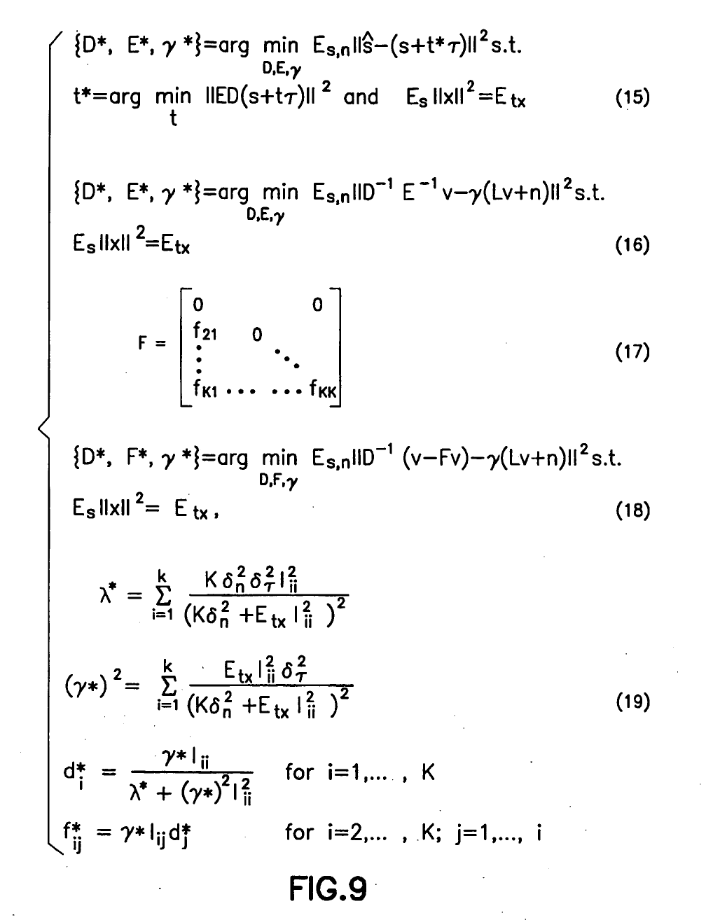

In an exemplary embodiment of the invention, there is provided a MMSE solution that jointly optimizes the linear filter and non-linear perturbation vectors wherein equations relating to the following exemplary derivation are illustrated in FIG. 9 and are referred to by their accompanying equation numbers. Once again, one starts from the precoder representation illustrated in FIG. 3 while keeping the unitary matrix Q 20C the same as in the ZF solution.

First, one derives the joint optimization algorithm for a slow fading scenario similar to the ZF case, wherein the joint optimization problem in the MMSE sense is give by equation (15).

Since the explicit forms of the E and D matrices 20B, 20A are not known in the MMSE case, one is not able to extend the method used with regards to ZF to decouple the optimization of t and (D, E, γ).

However, observing in FIG. 3 that ŝ=γ(HQ^{H}v+n)=γ(Lv+n) and s+t*τ=D⁻¹E⁻¹v, one can rewrite (15) as equation (16).

There is therefore removed the first constraint in equation (15) since the cost function no longer explicitly depends on the optimal perturbation vectors t*. All that is required is the second-order statistics of v, which are known to be Rᵥ=DD^{H}σ_{τ}² as discussed above.

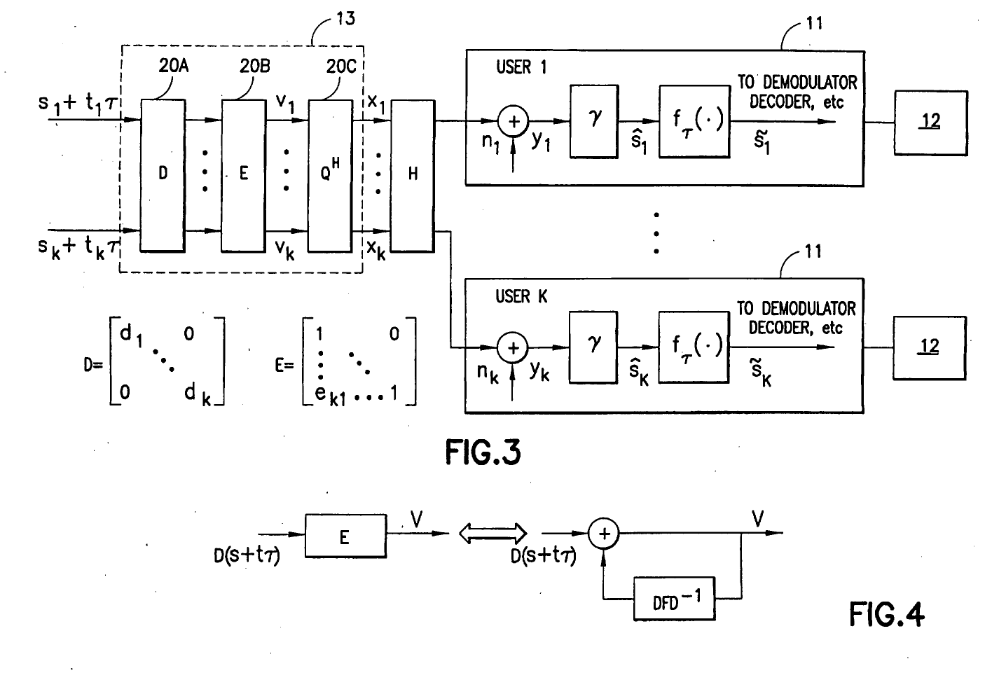

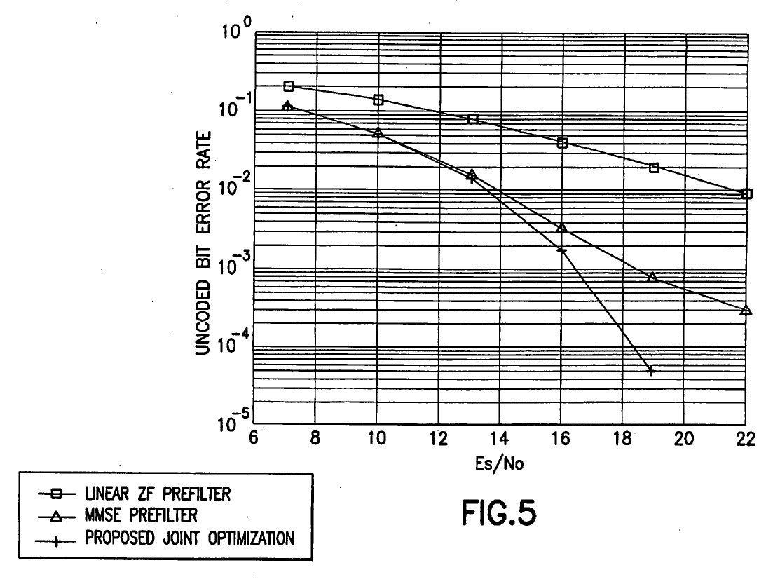

One can further simplify the cost function in (16) by noticing that since E 20B is a lower triangular matrix with all one diagonals, E⁻¹ is also a lower triangular matrix with all one diagonals. Therefore, one can let E⁻¹=I−F where F, as illustrated in equation (17), is a strictly lower triangular matrix with all zero diagonals, and rewrite equation (16) to read as equation 18 whose solution is given in the following Theorem using Lagrange multipliers. F is also known as the “decision-feedback filter” matrix wherein one represents matrix E 20B in the alternative form as shown in FIG. 4.

As a result, the solution of the optimization problem in equation (18) is shown as equation (19).

By definition, the above derived MMSE solution should reduce to the ZF solution at a high signal to noise ratio (SNR). This can be readily verified. It is clear from (19) that as σₙ²−0λ*−0 and

$${( {γ}^{*} )}^{2} \to \frac{1}{{E}_{tx}} {\sum }_{i = 1}^{K} \frac{{σ}_{τ}^{2}}{{l}_{ii}^{2}}$$

$${d}_{i}^{*} \to \frac{1}{γ {l}_{ii}} ,$$

which is the ZF solution obtained in the previous section.

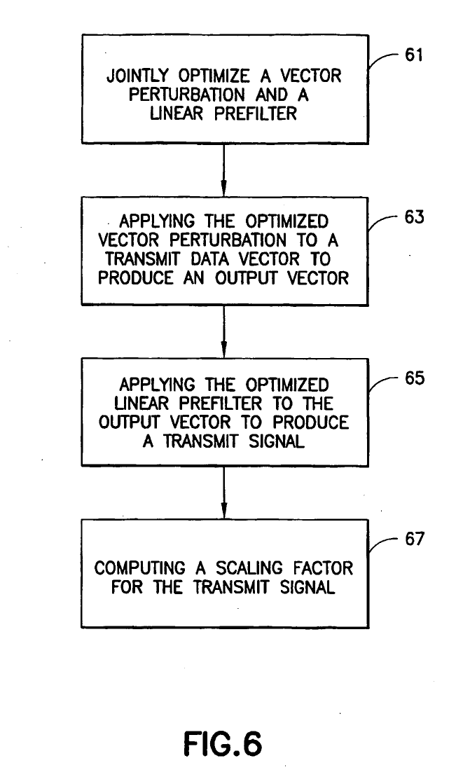

With reference to FIG. 6, there is illustrated a flow chart of an exemplary embodiment of a method of the invention. At block 61, a vector perturbation and a linear pre-filter are jointly optimized as described above. Such joint optimization may be performed at a transmitter. At block 63, the optimized vector perturbation is applied to a transmit input vector to produce an output vector. At block 65, the optimized linear pre-filter is applied to the output vector to produce a transmit signal. At block 67, a scaling factor for the transmit signal is computed. This scaling factor is transmitted from the transmitter to a receiver and is utilized by the receiver to process the transmit signal.

With reference to FIG. 5, an exemplary embodiment of the method of the invention is evaluated in a realistic link-level MIMO-OFDM simulator conforming to the physical layer specifications of the IEEE 802.16e standard (also known as WIMAX). Some of the simulation parameters are tabulated in Table 1. There is assumed to be no feedback delay and, therefore, perfect channel information at the BS 13.

TABLE 1

| Parameter Name | Parameter Value | |
|---|---|---|
| System | IEEE 802.16 (WIMAX) | |
| Bandwidth | 10 | MHz |
| Channel Profile | Ped B | |
| Feedback Delay | 0 | s |
| FFT Size | 1024 | |
| Permutation Zone | AMC | |
| Data Sub-Carrier Num | 32 | kbps |

The efficacy of the exemplary embodiment of the joint optimization method of the invention is evident in the illustrated results of the simulation. There is assumed four BS 13 transmit antennas, and four MS 11 users in a cell each with 1 receive antenna. Furthermore, Quadrature Phase Shift Keying (QPSK) modulation is used in the simulations and the uncoded bit error rate curves are plotted against the SNR. It is apparent that MMSE pre-filtering obtained from the joint optimization algorithm of exemplary embodiments of the invention provides good results. Specifically, for a given signal to noise ratio (Es/No), the uncoded bit error rate resulting from the use of the jointly optimized method of the invention is lower than for either the non-jointly optimized ZF pre-filtering instance, or the non-jointly optimized MMSE pre-filtering instance.

In general, the various embodiments of the MS 11 can include, but are not limited to, cellular telephones, portable electronic devices, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention involving vector perturbation, linear pre-filtering, and scaling factor computation may be implemented by computer software executable by a data processor of the BS 13, such as the processing unit 15, or by hardware, or by a combination of software and hardware.

The memory 17 may be of any type suitable to the local technical environment and may be implemented using any suitable data storage technology, such as semiconductor-based memory devices, magnetic memory devices and systems, optical memory devices and systems, fixed memory and removable memory. The processing unit 15 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments such as performing vector perturbation, linear pre-filtering, scaling factor computation, decoding, and demodulating may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Certain embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for processing a transmit signal comprising:
jointly optimizing a vector perturbation and a linear pre-filter (G);
applying said optimized vector perturbation to a transmit data vector (s) to produce an output vector; and
applying said optimized linear pre-filter (G) to said output vector to produce a transmit signal (x).

2. The method of claim 1 comprising computing a scaling factor (γ) for said transmit signal.

3. The method of claim 2 comprising transmitting said transmit signal and said scaling factor to a receiver.

4. The method of claim 1 wherein jointly optimizing comprises decoupling an optimization of said vector perturbation from an optimization of said linear pre-filter.

5. The method of claim 1 wherein said linear pre-filter comprises a zero forcing (ZF) linear pre-filter.

6. The method of claim 5 wherein
$$γ = sqrt ( {E}_{tx} / {\sum }_{n = 1}^{N} ‖ {{H}^{- 1} ( s ( n ) + τ t ( n ) ‖}^{2} ) ,$$
where r=2(|s|ₘₐₓ+Δ), H comprises a channel matrix, Eₜₓ comprises a transmission power, and t comprises a time.

7. The method of claim 5 wherein said output vector comprises s+tτ and said transmit vector comprises G(s+tτ) where τ=2(|s|ₘₐₓ+Δ) G=(1/γ)H−1, t=arg minₜ∥H⁻¹(s+tτ)∥²,
$$γ = sqrt ( {E}_{tx} / {\sum }_{n = 1}^{N} {‖ {H}^{- 1} ( s ( n ) + τ t ( n ) ) ‖}^{2} ) , H$$
comprises a channel matrix, and t comprises a time.

8. The method of claim 1 wherein said linear pre-filter comprises a Minimum Mean Square Error (MMSE) linear pre-filter.

9. The method of claim 8 wherein said linear pre-filter comprises a diagonal matrix (D), a lower triangular matrix (E), and a uniform matrix (Q) wherein said D, E, and γ comprise a solution to
$$\{ {D}^{*} , {E}^{*} , {γ}^{*} \} = arg {min}_{D , E , γ} {E}_{s , n} {‖ \hat{s} - ( s + {t}^{*} τ ) ‖}^{2} s . t . \\ {t}^{*} = arg {min}_{t} {‖ ED ( s + t τ ) ‖}^{2} and {E}_{s} {‖ x ‖}^{2} = {E}_{tx}$$
wherein E=(I−DFD⁻¹)⁻¹, and wherein said diagonal matrix D, an F matrix, and said γ are as follows:
$${λ}^{*} = {\sum }_{i = 1}^{k} \frac{K {σ}_{n}^{2} {σ}_{τ}^{2} {I}_{ii}^{2}}{{( K {σ}_{n}^{2} + {E}_{tx} {I}_{ii}^{2} )}^{2}}$$
$${( {γ}^{*} )}^{2} = {\sum }_{i = 1}^{k} \frac{{E}_{tx} {I}_{ii}^{2} {σ}_{τ}^{2}}{{( K {σ}_{n}^{2} + {E}_{tx} {I}_{ii}^{2} )}^{2}}$$
$$\begin{matrix}{d}_{i}^{*} = \frac{{γ}^{*} {I}_{ii}}{{λ}^{*} + {( {γ}^{*} )}^{2} {I}_{ii}^{2}} & for i = 1 , … , K \\ {f}_{ij}^{*} = {γ}^{*} {I}_{ij} {d}_{j}^{*} & for i = 2 , … , K ; j = 1 , … , i .\end{matrix}$$

10. A method of claim 1 comprising transmitting said scaling factor to a receiver.

11. The method of claim 1 comprising applying said vector perturbation to said transmit data vector at a base station (BS) and transmitting said transmit signal and said scaling factor to at least one mobile station (MS).

12. The method of claim 11 wherein said linear pre-filter comprises a zero forcing (ZF) linear pre-filter.

13. The method of claim 12 wherein said linear pre-filter comprises a Minimum Mean Square Error (MMSE) linear pre-filter.

14. A transmitter comprising:
means for jointly optimizing a vector perturbation and a linear pre-filter (G);
means for applying said optimized vector perturbation to a transmit data vector (s) at a base station (BS) to produce an output vector;
means for applying said optimized linear pre-filter to said output vector at said BS to produce a transmit signal (x);
means for computing a scaling factor (γ); and
means for transmitting said transmit signal and said scaling factor to at least one mobile station (MS).

15. The transmitter of claim 14 wherein said means for optimizing, said means for applying, and said means for computing comprise a processing unit.

16. The transmitter of claim 14 wherein said linear pre-filter comprises a zero forcing (ZF) linear pre-filter.

17. The transmitter of claim 14 wherein said linear pre-filter comprises a Minimum Mean Square Error (MMSE) linear pre-filter.

18. The transmitter of claim 14 wherein said transmitter comprises a base station.

19. A receiver comprising:
means for receiving a transmit signal and a scaling factor wherein said transmit signal comprises a transmit data vector to which is applied a vector perturbation and a linear pre-filter and wherein said vector perturbation and said linear pre-filter are jointly optimized; and
means for applying said scaling factor to said transmit signal to derive said transmit data vector.

20. The receiver of claim 19 wherein said receiver comprises a mobile station.

21. A program of machine-readable instructions, tangibly embodied on an information bearing medium and executable by a digital data processor, to perform actions, the actions comprising:
jointly optimizing said vector perturbation and said linear pre-filter;
applying said optimized vector perturbation to a transmit data vector (s) at a base station (BS) to produce an output vector;
applying said optimized linear pre-filter (G) to said output vector at said BS to produce a transmit signal (x); and
computing a scaling factor (γ).

22. The program of claim 21 comprising directing the transmission of said transmit signal and said scaling factor to at least one mobile station.

23. The program of claim 21 wherein said linear pre-filter comprises a zero forcing (ZF) linear pre-filter.

24. The program of claim 21 wherein said linear pre-filter comprises a Minimum Mean Square Error (MMSE) linear pre-filter.
